(19) United States
(12) Patent Application Publication
(10) Pub. No.: US 2006/0114235 A1
(43) Pub. Date: Jun. 1, 2006

(54) Mechanism and method for entering data

(76) Inventor: David Lee Larom, San Diego, CA (US)

Correspondence Address: QUALCOMM, INC, 5775 MOREHOUSE DR., SAN DIEGO, CA, 92121, US

(21) Appl. No.: 10/989,683

(22) Filed: Nov. 15, 2004

(51) Int. Cl. G09G 5/00

(52) U.S. Cl. 345/169

(57) ABSTRACT

Described are methods and mechanisms for entering data using a limited keyboard. Very generally stated, the invention envisions a mechanism and method for entering data on a keypad having a limited number of buttons. Each of several characters is mapped to a two-button pairing on the input device. A first button represents a group of characters, and a second button represents a position within that group of the desired character.

### BACKGROUND OF THE INVENTION

The invention relates generally to the field of input mechanisms, and more particularly to input mechanisms on mobile devices.

Cellular telephones and similar handheld mobile devices have achieved widespread acceptance. So much so that they are routinely tasked as multi-function devices. For instance, the same handheld mobile device may be used as a cellular telephone, personal digital assistant, e-mail client, and instant messaging device. However, one limitation of most handheld mobile devices is the input mechanism, which is often a standard twelve-button keypad.

Using a twelve-button keypad to input text is a difficult problem because the number of possible characters greatly exceeds the number of available buttons. There have been a few attempts at solving this problem that are, for different reasons, less than ideal. The most common method for character input using a twelve-button keypad is “triple-tapping.” Triple-tapping involves using a keyboard with a limited number of buttons where each button includes a set of characters. To select a particular character from a set of characters, its button is pressed a number of times equal to that character's location in the set. For instance, if the set of characters on a button includes “d”, “e”, and “f”, one would select the character “e” by pressing the button twice. Similarly, one would select the “f” by pressing the button three times.

Triple-tapping is a very slow process for different reasons. First, the user must press the same button a different number of times depending on which letter the user desires, up to three presses for several letters, and as many as four presses for certain letters. This confuses many users. In addition, there are many words that have two consecutive characters in the same group of characters on a button, such as “hello.” Thus, the user may often not be able to simply continue pressing buttons based on the desired letter; in some cases the user must wait before pressing the same button again to give the device time to accept the last character. This delay adds time to an already slow text entry method.

Another method for character input using a limited keypad is named “T9,” which is a predictive text entry method developed by Tegic Communications in Seattle, Wash. The T9 method is predictive because it associates sequences of groups of letters found on each keypad button with a dictionary of common words. A T9 enabled input device accepts a button press and begins to display the most common word that begins with any letter in the group of letters associated with the pressed button. As the user presses subsequent buttons, the input device updates the display with the most common word associated with the button sequence being pressed. This process continues until either the user identifies a word as correct or changes to another input method, such as triple-tapping. For example, if the user first presses a button that is associated with the characters “g”, “h”, and “I”, the T9 enabled device may first display the word “I” because that may be the most common word associated with only that single button sequence. However, if the user next presses a button associated with the characters “m”, “n”, and “o”, the device may change the displayed word to “in” because that is the most common word associated with the two button sequence that has been entered. Finally, if the user next presses a button associated with the characters “w”, “x”, “y”, and “z”, the device may change the displayed word to “how” because that word is most commonly associated with the three button sequence. When the desired word is finally displayed, the user selects that word, usually with a dedicated button.

Although an improvement over triple-tapping, T9 is not without its limitations. For example, the user must switch to another input mechanism to input numbers, special characters, and words that are not in the device's dictionary. These types of messages are more common when using mobile devices where it is common to type e-mail addresses or abbreviated phrases (e.g. “imo” for “in my opinion”). Switching back and forth between input mechanisms can make using T9 even slower than triple-tapping for messages commonly sent using mobile devices.

An adequate method and mechanism for entering data on a device with a limited keypad has eluded those skilled in the art, until now.

### SUMMARY OF THE INVENTION

The invention is directed to methods and mechanisms for entering data on a keypad having a limited number of buttons using a mapping from characters to two-button pairings. In one aspect, the invention envisions a mechanism for entering data into a device that includes a keypad with a plurality of groups of buttons, at least one of the buttons having an associated set of characters, each group of buttons having a position relative to the other groups of buttons. In addition, a keypad control device is included and configured to perform several tasks. One task is to recognize a signal indicating a selection of a first button, the first button being associated with a first group within the groups of buttons. Another task is to recognize a signal indicating a selection of a second button, the second button having an associated set of characters, each character in the associated set of characters having a position relative to the other characters in the associated set of characters. And the final task is to identify a selected character as the character within the associated set of characters that has a same position relative to the other characters as the position of the first group relative to the other groups of buttons.

In another aspect, the invention is implemented on a device having a keypad with a plurality of groups of buttons, at least one of the buttons having an associated set of characters, each group of buttons having a position relative to the other groups of buttons, a method of identifying a character. The invention is directed at receiving a signal indicating a selection of a first button, the first button being associated with one of the groups of buttons. Another signal is received indicating a selection of a second button, the second button having an associated set of characters, each character in the associated set of characters having a position relative to the other characters in the associated set of characters. After receiving notice of the two button presses, a character is selected within the associated set of characters that has a same position relative to the other characters as the position of the group of buttons that includes the first button relative to the other groups of buttons.

In yet another aspect, the invention is implemented on a device having a keypad with a limited number of buttons. The invention envisions a method of identifying a character that includes receiving a signal indicating a selection of a position button, and receiving another signal indicating a selection of a group button. Then a desired character is determined by referring to mapping information that maps characters to two-button pairings where the position button is used as one button in the two-button pairings, and the group button is used as the other button in the two-button pairing.

### BRIEF DESCRIPTION OF THE DRAWINGS

FIG. 1 is a functional block diagram generally illustrating a mobile device having a keypad under the control of a keypad control device, in accordance with an implementation of the invention.

FIG. 2 is a graphical illustration of a sample mobile device with a keypad that is configured to operate in accordance with the invention.

FIGS. 3A and 3B illustrate another example of the operation of one implementation of the invention.

FIG. 4 is a conceptual illustration of enhancements to the general concepts described in conjunction with FIGS. 1 through 3.

FIG. 5 is a graphical illustration of a sample keypad arrangement that is configured to operate in accordance with the invention.

FIG. 6 is another graphical illustration of a sample keypad arrangement that is configured to operate in accordance with the invention.

FIG. 7 is an operational flow diagram generally illustrating a process for entering data using a keypad having a limited number of buttons.

FIG. 8 is another operational flow diagram generally illustrating a process for entering data using a keypad having a limited number of buttons.

### DETAILED DESCRIPTION

What follows is a detailed description of various techniques and mechanisms for entering data using a limited keyboard. Very generally stated, the invention envisions a mechanism and method for entering data on a keypad having a limited number of buttons. Each of several characters is mapped to a two-button pairing on the input device. A first button represents a group of characters, and a second button represents a position within that group of the desired character.

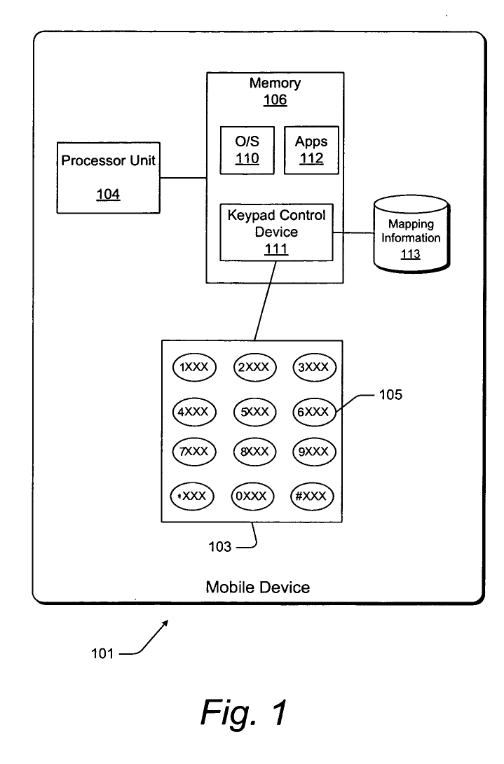

FIG. 1 is a functional block diagram generally illustrating a mobile device 101 having a keypad 103, a processor unit 104 (that can include a general purpose processor, a specialized communications processor and/or a digital signal processor), and a memory 106. In this embodiment, memory 106 is used to store an operating system 110, one or more applications 112, and a keypad control device 111, which are to be executed by the processor unit 104. The keypad control device 111 may be a software driver or other module used to control the keypad 103. Alternatively, the keypad control device 111 may be implemented in hardware or firmware.

The mobile device 101 may be any handheld mobile device that is provided with a limited keypad. Common examples of such a mobile device include cellular telephones, personal digital assistants, global positioning satellite units, portable music players, and the like. In this implementation, the keypad 103 is a standard twelve-button keypad such as is in common use on many cellular telephones. The keypad 103 is capable of recognizing dual button presses. This can take the form of a simple dual press in which the first button then the second are pushed and released, or the first can be pressed, held and not released until the second button is pushed. Most, if not all, of the buttons on the keypad 103 have an associated group of characters. The character groups are any subset of characters contained within the entire set of characters that may be input using the input device. Generally speaking, each group of characters contains the same number of characters as other groups, although having groups with different numbers of characters is possible, and indeed likely with certain implementations. While the invention is not dependent on the particular groupings of characters, some standard groupings exist in the industry. For example, it is common for the 6 button 105 to be associated with the characters “m”, “n”, and “o”.

The keypad control device 111 is the mechanism that receives notice from the keypad 103 of button presses and determines which character has been selected. In accordance with the invention, the keypad control device 111 refers to button mapping information 113 that maps button pairs to characters to determine which character has been selected. More specifically, two buttons on the keypad 103 may be simultaneously or near simultaneously pressed to identify a single character. One of the two buttons identifies a particular grouping of characters, and the other button identifies a position within that particular grouping for the desired character. For the purpose of this application, the term “group button” will be used to refer to the former, and the term “position button” will be used to refer to the latter. The mapping information 113 identifies which character results from a particular group button-position button pairing.

In operation, a user of the device presses a group button to identify the particular group within which the desired character is located. The user also presses a position button to identify the particular position of the desired character within the group. The keypad control device 111 refers to the mapping information 113 to determine which character is the desired character. The general concepts just described are best illustrated by way of example.

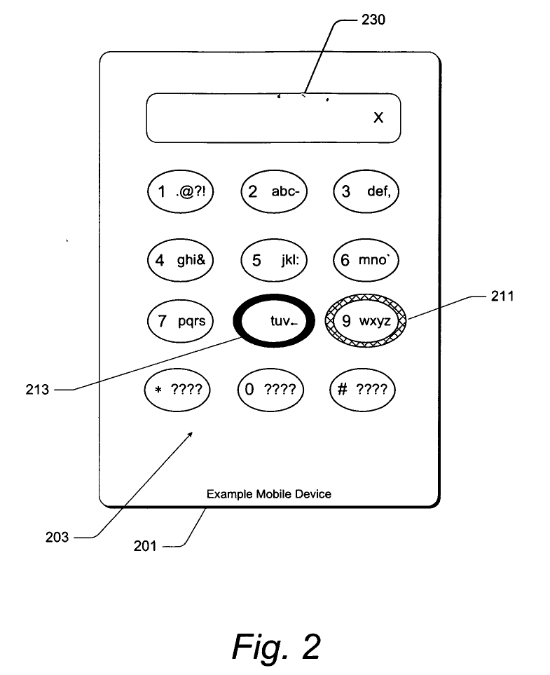

FIG. 2 is a graphical illustration of a sample mobile device 201 with a keypad 203 that is configured to operate in accordance with the invention. Each button of the keypad 203 includes a group of characters. The particular arrangement of groups of characters illustrated in FIG. 2 is but one example, and many other arrangements are possible. To illustrate the concept, a user that desires to input the letter “x” first presses a group button that identifies the particular group of characters within which exists the letter “x”. In this example that is the 9 button 211, having the “wxyz” grouping. In addition, the user presses another button that identifies the position within that group of the desired character. In this example, the letter “x” is the second character in the grouping. Accordingly, the user presses the second button on the same row as the group button, which is the 8 button 213. Once the user has pressed both buttons, the keypad control device within the mobile device 201 determines that the “x” character has been selected, and that character is displayed on a screen 230.

It is important to note that the particular order of button selection must match the button mappings that will be used to determine characters for a particular implementation. In other words, if the input device expects the group button to be pressed first, then the first button pressed will be interpreted as the group button. Accordingly, while it is important in each implementation, it is not important to the invention whether the group button or the position button be pressed first.

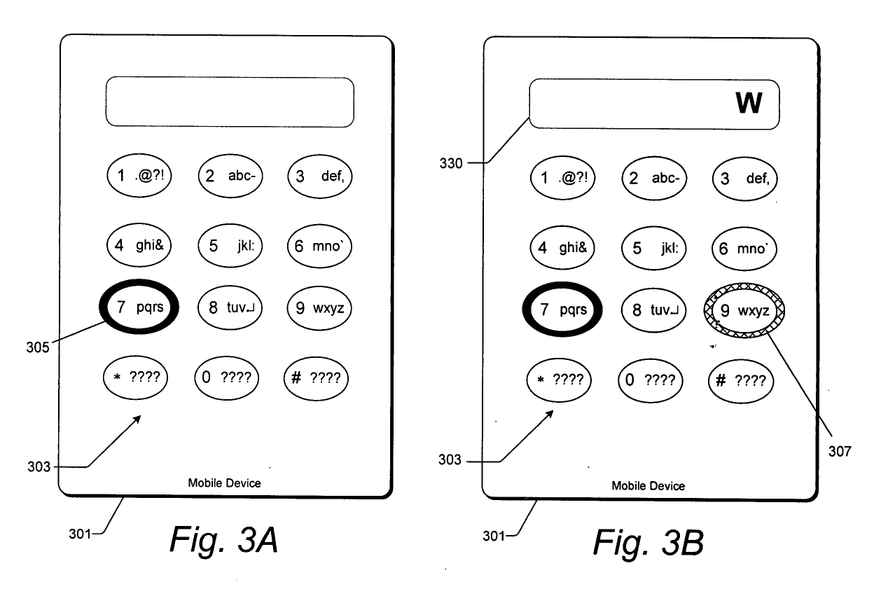

FIGS. 3A and 3B illustrate another example of the operation of one implementation of the invention. Again, a mobile device 301 is illustrated having a keypad 303 that is configured to operate in accordance with the invention. In this example, a user desires to select the letter “w”. Thus, the user first presses and holds the 7 button 305 (see FIG. 3A), and then presses the 9 button 307 (see FIG. 3B), resulting in the letter “w” being displayed on the screen 330. Note that in this example, the first button pressed (the 7 button 305) identified the position of the desired character within a set of characters, and the second button pressed (the 9 button 307) indicated the particular group of characters within which the desired character is located. Thus, in contrast to the example illustrated in FIG. 2, the ordering in FIGS. 3A and 3B is position-button first.

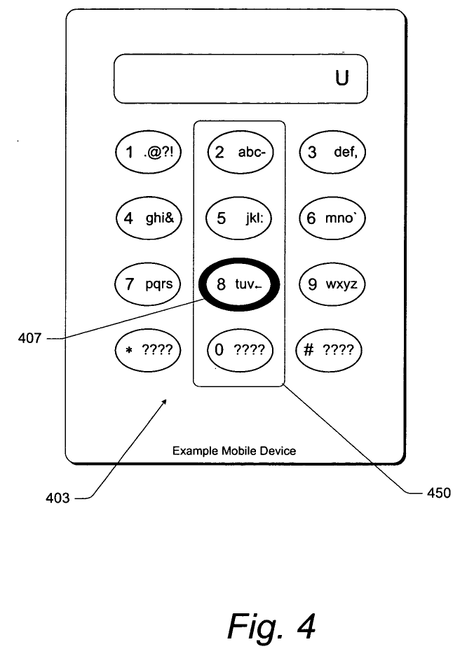

FIG. 4 is a conceptual illustration of enhancements to the general concepts described above. More specifically, FIG. 4 illustrates the concept that the position button need not be on the same row as the group button. Rather a more general notion of position may be obtained from the relative position of the button pressed to the keypad 403 itself. In other words, the keypad 403 generally has a left side and a right side. In one implementation, the position identification may be derived from the position of a column of buttons 450 within which the position button is located relative to the keypad 403. Although a column of buttons 450 is illustrated in FIG. 4, it will be appreciated that any group of buttons having a similar position relative to the keypad may be used, and the invention is not necessarily limited to columns of buttons.

Thus, if a user desires to select the character “u”, the user may first press the appropriate group button (the 8 button 407). However, in the case where the desired character is the second character in that group, the user cannot press and hold the 8 button 407 while also pressing the 8 button 407 again. Rather, the user may press any other button in the column 450 since the buttons in column 450 are each two positions from the left of the keypad 403), having the same effect.

In the solution described above, each character requires two button presses: A group button and a position button. In the implementation in which the first button is held while the second is pressed, it is possible that one of the characters in the group can be specified with just one press. When a button is pressed and released before a second button is pressed, a default character is chosen. A logical implementation could be to associate the middle character of a three-character group with a single button press. This could prove more intuitive than the case just described, in which a button in the same column but another row must be pressed. Another implementation relevant to the standard 12-button phone keypad would be to associate the single button press with the number associated with each character group. Thus “g”, “h” and “i” might each require two presses, but a single press of this button could create a “7”.

The above described concepts apply directly to a keypad where each button of the keypad is associated with a three-button group of characters, and the keypad includes three columns of buttons. However, the concepts may be extended such that each button on a keypad is associated with a four-button group of characters, e.g., “wxyz.” In that case, one row of buttons can be used to specify additional characters within a group. A logical example for the 12-button cell phone keypad could be to choose the “* 0 #” row of buttons and use “*” to specify the fourth character. This enables the “s” in “7pqrs” and the “z” in “9wxyz” to be specified with two button presses, and enables special characters to be included as the fourth character in the remaining character groups. A sample implementation of this sort is shown in FIG. 4. This has the additional advantage that the number on each button can be specified with the “#” sign; this is somewhat intuitive since “#” is traditionally associated with numbers.

In addition, another alternative embodiment may identify button pairings based solely on the order of button presses without the requirement that the first button be held while the second is pressed. In other words, the input device may identify each pair of two button presses as a single entry regardless of whether the two buttons are simultaneously pressed.

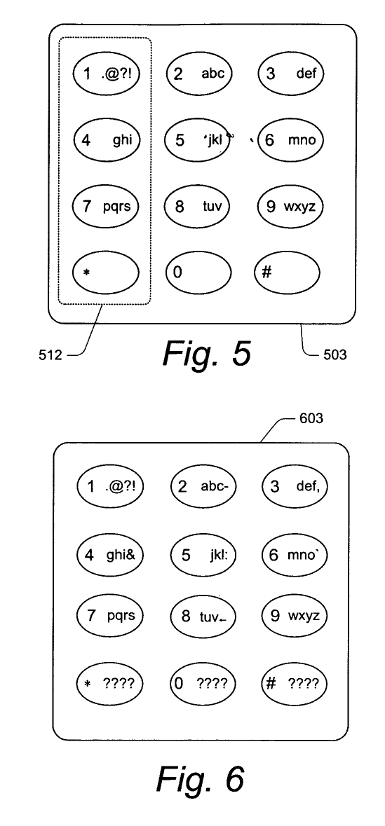

The following Table 1 includes one sample mapping of desired characters to two-button pairings. This sample mapping is associated with the three-character groupings shown on the keypad layout 503 illustrated in FIG. 5. In this sample mapping, the position button is pressed first, and the group button is pressed while holding the position button. Note that this table illustrates the opposite button-press order as that described in conjunction with the examples of FIGS. 3 and 4 to demonstrate the flexibility of the invention.

TABLE 1

| Desired | Position | Group |
|---|---|---|
| Character | Button | Button |
| a | 1 | 2 |
| b | — | 2 |
| c | 3 | 2 |
| d | 1 | 3 |
| e | — | 3 |
| f | 2 | 3 |
| g | 5 | 4 |
| h | — | 4 |
| i | 6 | 4 |
| j | 4 | 5 |
| k | — | 5 |
| l | 6 | 5 |
| m | 4 | 6 |
| n | — | 6 |
| o | 5 | 6 |
| p | 8 | 7 |
| q | — | 7 |
| r | 9 | 7 |
| s | * | 7 |
| t | 7 | 8 |
| u | — | 8 |
| v | 9 | 8 |
| w | 7 | 9 |
| x | — | 9 |
| y | 8 | 9 |
| z | * | 9 |
| 0 | # | 0 |
| 1 | # | 1 |
| 2 | # | 2 |
| 3 | # | 3 |
| 4 | # | 4 |
| 5 | # | 5 |
| 6 | # | 6 |
| 7 | # | 7 |
| 8 | # | 8 |
| 9 | # | 9 |

In the above table, the dash symbol “—” indicates that the desired character has the same position within the group as the group button does on the keypad, giving rise to the problem introduced above that the same button cannot be simultaneously pressed twice as both the group button and as the position button. Accordingly, one of the other buttons in the same column may possibly be used as the position button, such as described in conjunction with FIG. 4. Alternatively, the desired character may be selected using the single-button press solution just described above. Likewise, the non-simultaneous ordered button press solution could be used, for example, to select the “e” by simply pressing and releasing the “3” button twice.

Note that the pound sign (#) is used as a position button associated with the several numerals from zero (0) to nine (9). The actual desired numeral is associated with the group of characters on the button on which the numeral exists, and the pound sign (#) is used to indicate its position within that group. This example illustrates that the position button need not necessarily correspond to the actual physical position of the desired character within the group. Similarly, It should be mentioned that the groupings of characters need not all necessarily reside on the same button. These features allow a very large number of characters to be mapped with the two-button pairings using a relatively limited keypad. This feature could be especially helpful to input text or data in other languages that have very large numbers of characters, such as several Asian languages.

Note also that the asterisk symbol (*) is used in some cases in the table to indicate a special symbol or a fourth position. This example illustrates the use of a specially-designated button to indicate a special position within a particular group, such as a group that includes four characters. If a specially-designated button is used to indicate a fourth (or other) position, then that specially-designated button should not be included as a designator of position in the ordinary manner. In other words, referring to FIG. 5, if the asterisk symbol (*) is used as a special position button (e.g., a fourth position), then it should not be used in the same manner as the other buttons in the first column of buttons 512 to indicate the first position within the group. The same is true for the pound sign (#).

The following Table 2 includes another sample mapping, in which each button on a keypad has an associated four-character grouping, as shown on the keypad layout 603 illustrated in FIG. 6. In this example, the asterisk button 611 is used as a specially designated position button for use when selecting the fourth position within the group. In addition, several common symbols are included in the groupings, thus simplifying the input of non-ordinary words, such as e-mail addresses, or other symbols, such as the carriage return <CR>.

TABLE 2

| Desired | Position | Group |
|---|---|---|
| Character | Button | Button |
| a | 1 | 2 |
| b | — | 2 |
| c | 3 | 2 |
| d | 1 | 3 |
| e | — | 3 |
| f | 2 | 3 |
| g | 5 | 4 |
| h | — | 4 |
| i | 6 | 4 |
| j | 4 | 5 |
| k | — | 5 |
| l | 6 | 5 |
| m | 4 | 6 |
| n | — | 6 |
| o | 5 | 6 |
| p | 8 | 7 |
| q | — | 7 |
| r | 9 | 7 |
| s | * | 7 |
| t | 7 | 8 |
| u | — | 8 |
| v | 9 | 8 |
| w | 7 | 9 |
| x | — | 9 |
| y | 8 | 9 |
| z | * | 9 |
| 0 | 0 | # |
| 1 | 1 | # |
| 2 | 2 | # |
| 3 | 3 | # |
| 4 | 4 | # |
| 5 | 5 | # |
| 6 | 6 | # |
| 7 | 7 | # |
| 8 | 8 | # |
| 9 | 9 | # |
| . | 2 | 1 |
| @ | — | 1 |
| ? | 3 | 1 |
| ! | * | 1 |
| - | * | 2 |
| , | * | 3 |
| & | * | 4 |
| : | * | 5 |
| ′ | * | 6 |
| <CR> | * | 7 |

The following Table 3 includes still another sample mapping, in which each button on a keypad has an associated character grouping, again as shown on the keypad layout 603 illustrated in FIG. 6. In this example, unlike the examples in Table 1 or Table 2, each character is associated with a two button ordered pairing but it is not required to hold the first button while pressing the second. So to select the character “b”, the user would press and release the “2” button, and then press and release the “2” button again. This implementation has certain advantages over others, such as being simpler to perform with a single hand or finger.

TABLE 3

| Desired | Position | Group |
|---|---|---|
| Character | Button | Button |
| a | 1 | 2 |
| b | 2 | 2 |
| c | 3 | 2 |
| d | 1 | 3 |
| e | 2 | 3 |
| f | 3 | 3 |
| g | 4 | 4 |
| h | 5 | 4 |
| i | 6 | 4 |
| j | 4 | 5 |
| k | 5 | 5 |
| l | 6 | 5 |
| m | 4 | 6 |
| n | 5 | 6 |
| o | 6 | 6 |
| p | 7 | 7 |
| q | 8 | 7 |
| r | 9 | 7 |
| s | * | 7 |
| t | 7 | 8 |
| u | 8 | 8 |
| v | 9 | 8 |
| w | 7 | 9 |
| x | 8 | 9 |
| y | 9 | 9 |
| z | * | 9 |
| 0 | # | 0 |
| 1 | # | 1 |
| 2 | # | 2 |
| 3 | # | 3 |
| 4 | # | 4 |
| 5 | # | 5 |
| 6 | # | 6 |
| 7 | # | 7 |
| 8 | # | 8 |
| 9 | # | 9 |
| . | 1 | 1 |
| @ | 2 | 1 |
| ? | 3 | 1 |
| ! | * | 1 |
| - | * | 2 |
| , | * | 3 |
| & | * | 4 |
| : | * | 5 |
| ′ | * | 6 |
| <CR> | * | 8 |

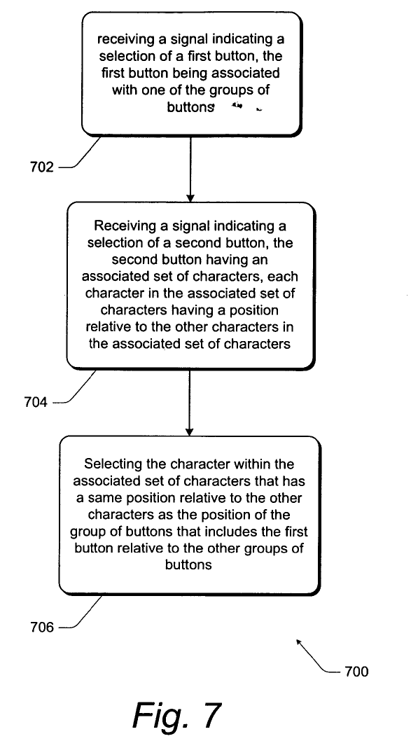

FIG. 7 is an operational flow diagram generally illustrating a process 700 for entering data using a keypad having a limited number of buttons. This process 700 may be implemented in various manners using various devices. However, it is envisioned that the process 700 has particular applicability in the area of mobile devices where the problems of limited keypads are particularly acute. The process is executed on a device having a keypad with buttons. Most, if not all, of the buttons are associated with a set or group of characters. The buttons can be aggregated into certain collections, such as columns. Each collection of buttons has a position relative to the other collections. For example, one column of buttons may have a right-most position relative to another column. In addition, a collection could be a single button.

At step 702 of the process 700, a signal is received that indicates a selection of a first button. The signal is received at a keypad control device, which may be some logic or programming that is responsible for interpreting button presses as characters. The first button is associated with one collection of buttons on the keypad.

At step 704, a signal is received that indicates a selection of a second button that has an associated group of characters. Each character in the associated group of characters has a position relative to the other characters in the group. For example, if the group of characters includes three letters, one of the letters may be a right-most letter, one may be positioned in the center, and one may be a left-most letter. Alternatively, if the group of characters includes numerals, then each numeral may be ordered numerically. Many other positions are also possible, depending on the particular group of characters.

At step 706, the desired character is identified as the character within the associated group of characters with the same position relative to the other characters as the position of the collection of buttons including the first button relative to the other collections of buttons. For example, if the collection of buttons was a right-most collection relative to the other collections, then the right-most character in the group of characters is identified as the desired character.

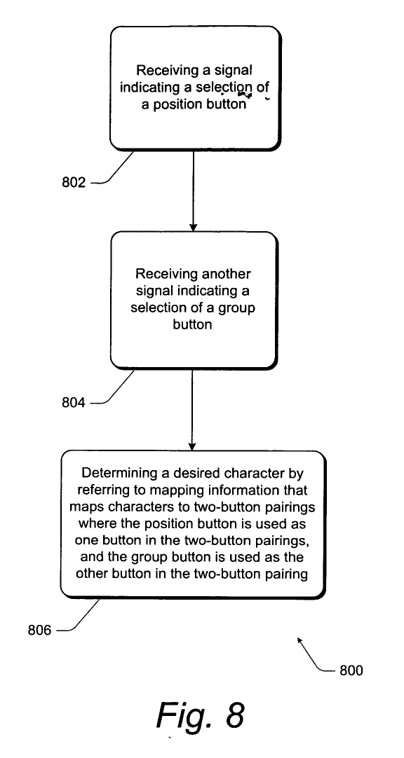

FIG. 8 is another operational flow diagram generally illustrating a process 800 for entering data using a keypad having a limited number of buttons. Again, it is envisioned that the process 800 has particular applicability for mobile devices having a keypad with buttons. Most, if not all, of the buttons have both a position characteristic and a group characteristic. The group characteristic of a button identifies a set of characters with which that particular button is associated. The position characteristic of a button identifies which character within any set of characters is a desired character.

At step 802 of the process 800, a signal is received indicating a selection of a position button. For example, one of the buttons on the keypad has been pressed, and its position characteristic has been determined.

At step 804, another signal is received indicating a selection of a group button. For example, another of the buttons on the keypad has been pressed, and its group characteristic has been determined.

At step 806, a desired character is identified by referring to mapping information that maps characters to two-button pairings. The position button that has been pressed is used as one button in the two-button pairings, and the group button that has been pressed is used as the other button in the two-button pairing.

It is important to note again that the signal receiving steps described in the two processes above may be performed in any order.

Using the techniques described above, a keypad having a limited number of keys can be extended to provide access to a much larger range of characters quite easily. By essentially using two buttons to identify each character, rather than just a single button, the number of characters that can be addressed with fewer buttons is dramatically increased. In addition, the ease of use of the keypad is not significantly impacted because many users of mobile devices will quickly adapt to using one finger on each hand to press buttons, such as both thumbs. Many users do so already.

The techniques described above are faster than either triple-tapping or T9 in may cases. In addition, the intuitive nature of pressing two buttons per character is quickly learned and avoids the need to switch back and forth between input modes depending on the content being entered. There are no delays if the same character is typed twice, as with triple-tapping.

It should be mentioned again that the ordered dual button press is used to define the characters, and there are implementations where the buttons may be pressed simultaneously or sequentially. In other words, each character could be identified by first pressing (and releasing) a first button, and then pressing a second button. Although this implementation has its disadvantages, such as the loss of overloading, it has some advantages, such as heuristic advantages or applications for the handicapped.

Although described throughout this document as buttons, it should be appreciated that any input mechanism having a plurality of individually selectable components may be used, such as “soft” keypads rendered on graphical displays, a set of toggle switches, touch sensitive membranes, and the like. Accordingly, the terms “keypad” and “button” should have the broadest meanings applicable to them, including any of the examples just given and others too numerous to recite here.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A mechanism for entering data into a device, comprising:
a keypad with a plurality of collections of buttons, at least one of the buttons having an associated set of characters, each collection of buttons having a position relative to the other collections of buttons; and
a keypad control device configured to:
recognize a signal indicating a selection of a first button, the first button being associated with a first collection within the collections of buttons,
recognize a signal indicating a selection of a second button, the second button having an associated set of characters, each character in the associated set of characters having a position relative to the other characters in the associated set of characters, and
identify a selected character as the character within the associated set of characters that has a same position relative to the other characters as the position of the first collection relative to the other collections of buttons.

2. The mechanism recited in claim 1, wherein the collections of buttons comprise columns of buttons.

3. The mechanism recited in claim 1, wherein the keypad is capable of recognizing simultaneous button presses.

4. The mechanism recited in claim 1, wherein the first button and the second button comprise an ordered pair, and the selected character is mapped to the ordered pair.

5. The mechanism recited in claim 1, wherein the keypad control device is configured to associate a first button press with the signal indicating the selection of the first button, and to associate a second button press with the signal indicating the selection of the second button.

6. The mechanism recited in claim 5, wherein the second button press begins prior to the first button press being released.

7. The mechanism recited in claim 5, wherein the second button press begins subsequent to the first button press being released.

8. The mechanism recited in claim 1, wherein the keypad control device is configured to associate a first button press with the signal indicating the selection of the second button, and a second button press with the signal indicating the selection of the first button.

9. The mechanism recited in claim 8, wherein the second button press begins prior to the first button press being released.

10. The mechanism recited in claim 8, wherein the second button press begins subsequent to the first button press being released.

11. A mechanism for entering data into a device, comprising:
means for providing a signal indicative of a button press;
means for recognizing a signal indicating a selection of a first button, the first button being associated with a first collection in a plurality of collections of buttons, each collection of buttons having a position relative to the other collections of buttons;
means for recognizing a signal indicating a selection of a second button, the second button having an associated set of characters, each character in the associated set of characters having a position relative to the other characters in the associated set of characters; and
means for identifying a selected character as the character within the associated set of characters that has a same position relative to the other characters as the position of the first collection relative to the other collections of buttons.

12. On a device having a keypad with a plurality of collections of buttons, at least one of the buttons having an associated set of characters, each collection of buttons having a position relative to the other collections of buttons, a method of identifying a character, comprising:
receiving a signal indicating a selection of a first button, the first button being associated with one of the collections of buttons;
receiving another signal indicating a selection of a second button, the second button having an associated set of characters, each character in the associated set of characters having a position relative to the other characters in the associated set of characters; and
identifying a selected character by selecting the character within the associated set of characters that has a same position relative to the other characters as the position of the collection of buttons that includes the first button relative to the other collections of buttons.

13. The mechanism recited in claim 12, wherein the first button and the second button comprise an ordered pair, and the selected character is mapped to the ordered pair.

14. The mechanism recited in claim 12, wherein the signal indicating the selection of the first button is received prior to the signal indicating the selection of the second button.

15. The mechanism recited in claim 12, wherein the signal indicating the selection of the first button is received subsequent to the signal indicating the selection of the second button.

16. A computer-readable medium having computer-executable instructions for identifying a character, comprising:
receiving a signal indicating a selection of a first button of a keypad, the first button being associated with one collection of a plurality of collections of buttons, each collection of buttons having a position relative to the other collections of buttons;
receiving another signal indicating a selection of a second button, the second button having an associated set of characters, each character in the associated set of characters having a position relative to the other characters in the associated set of characters; and
identifying a selected character by selecting the character within the associated set of characters that has a same position relative to the other characters as the position of the collection of buttons that includes the first button relative to the other collections of buttons.

17. The computer-readable medium recited in claim 16, wherein the first button and the second button comprise an ordered pair, and the selected character is mapped to the ordered pair.

18. The computer-readable medium recited in claim 16, wherein the signal indicating the selection of the first button is received prior to the signal indicating the selection of the second button.

19. The computer-readable medium recited in claim 16, wherein the signal indicating the selection of the first button is received subsequent to the signal indicating the selection of the second button.

20. On a device having a keypad with a limited number of buttons, a method of identifying a character, comprising:
receiving a signal indicating a selection of a position button;
receiving another signal indicating a selection of a group button; and
determining a desired character by referring to mapping information that maps characters to two-button pairings where the position button is used as one button in the two-button pairings, and the group button is used as the other button in the two-button pairing.

21. The method recited in claim 20, wherein the position button identifies a position of the position button relative to other buttons on the keypad.

22. The method recited in claim 20, wherein the group button is associated with a set of characters, each character in the associated set of characters having a character position relative to the other characters in the associated set of characters.

23. The method recited in claim 20, wherein the position button is associated with a relative position of the desired character with respect to other characters in a group of characters.

24. The method recited in claim 23, wherein the group button identifies the group of characters from among a plurality of groups of characters.

25. The method recited in claim 20, wherein the signal indicating the selection of a position button comprises the selection of the group button and releasing of the group button without a selection of another button.

26. A computer-readable medium having computer-executable instructions for identifying a character, comprising:
receiving a signal indicating a selection of a position button;
receiving another signal indicating a selection of a group button; and
determining a desired character by referring to mapping information that maps characters to two-button pairings where the position button is used as one button in the two-button pairings, and the group button is used as the other button in the two-button pairing.

27. The computer-readable recited in claim 26, wherein the position button identifies a position of the position button relative to other buttons on the keypad.

28. The computer-readable recited in claim 26, wherein the group button is associated with a set of characters, each character in the associated set of characters having a character position relative to the other characters in the associated set of characters.

29. The computer-readable recited in claim 26, wherein the position button is associated with a relative position of the desired character with respect to other characters in a group of characters.

30. The computer-readable recited in claim 29, wherein the group button identifies the group of characters from among a plurality of groups of characters.

31. The method recited in claim 20, wherein the signal indicating the selection of a position button comprises the selection of the group button and releasing of the group button without a selection of another button.
